(19) United States
(12) Patent Application Publication
(10) Pub. No.: US 2025/0201452 A1
(43) Pub. Date: Jun. 19, 2025

(54) Spray-Coated High-Voltage Busbar for a Vehicle, in Particular an Electric Vehicle

(71) Applicant: Intercable Automotive Solutions GmbH, Bruneck (IT)

(72) Inventor: Christoph Baumgartner, Bruneck (IT)

(21) Appl. No.: 18/964,842

(22) Filed: Dec. 2, 2024

(30) Foreign Application Priority Data
Dec. 13, 2023 (EP) 23216138

(51) Int. Cl. H01B 13/22; C23C 4/02; C23C 4/08; C23C 4/129; C23C 4/131; H01B 5/02

(52) U.S. Cl. CPC H01B 13/22; C23C 4/02; C23C 4/08; C23C 4/129; C23C 4/131; H01B 5/02

(57) ABSTRACT

A method for producing a high-voltage busbar for transmitting current in a vehicle is illustrated. The method includes providing a busbar body made of at least one of a copper metal or an aluminum metal as an oxide-layer-forming metal. The busbar body has a first contact region and at least one further contact region, each meant for a corresponding contact surface for establishing an electrical contact with the busbar body. The at least one further contact region is spatially separate from the first contact region. The method further includes spraying at least one of the contact regions with a material stream of a molten corrosion-protective metal and thereby building up the contact surface.

### CROSS-REFERENCE TO RELATED APPLICATIONS

This application claims priority to EP 23 216 138 filed Dec. 13, 2023, the entire disclosure of which is incorporated by reference.

### FIELD

The disclosure relates to a method of manufacturing a high-voltage busbar for transmitting current in a vehicle, in particular in an electrically driven vehicle, comprising providing a busbar body made of a copper metal or of an aluminum metal as an oxide-layer-forming metal, the busbar body having a first contact region and at least one further contact region spatially separated from the first contact region, which are each provided for a corresponding contact surface for establishing electrical contact with the busbar body and thus the busbar.

### BACKGROUND

In vehicles, especially vehicles with electric drives, large currents occur despite high voltages. This is the case, for example, during fast charging processes. Accordingly, busbars, i.e. solid power lines made from a solid material, are becoming more widespread as a replacement for the conventional braided wires used as power lines in vehicles.

One problem is that the contact surfaces of the busbars corrode easily due to the operating conditions. To avoid this, the busbars are coated, usually by electroplating in a conveyor belt transport process or in an immersion bath as a rack product. The entire busbar is typically coated with gold, silver, palladium, nickel and tin as well as alloys based on or containing these metals.

Tin contact surfaces can also be produced using the hot-dip tinning process, in which the busbar is fully or partially tinned in an immersion bath. There it is however difficult to achieve defined contact surface properties. The galvanic process is therefore the most common. The problem with the galvanic process is the large amount of resources required, for example large quantities of chemicals, energy and water are consumed, as well as considerable quantities of material for the coating.

As an alternative to the galvanic process, other approaches are also known, but these have not yet gained widespread acceptance.

EP 3 719 932 B1, for example, discloses a contact insert made of a different material than the busbar.

EP3091617 describes a method for producing at least one functional area limited to a partial surface of a contact element. A material coating in the form of a paste, a powder, a wire or a film is mechanically applied to the contact element and then the mechanical and chemical properties of the material coating are changed using high-energy thermal radiation.

DE 10 2022 105 707 A1 proposes a surface structure that penetrates into an oxide layer of the busbar in order to overcome the problem of oxidation of the contact surface.

The technical problem to be solved is therefore to provide a more resource-efficient, in particular more environmentally friendly, flexible and easy-to-use process for manufacturing a permanently reliable (high-voltage) busbar.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This problem is solved by the objects of the independent claims. Advantageous embodiments are apparent from the dependent claims, the description and the figures.

One aspect relates to a method of producing a high-voltage busbar (which may also be referred to as conductor rail) for transmitting current in a vehicle, in particular for transmitting current in an electrically powered vehicle. The vehicle can be a land-bound vehicle such as a motor vehicle, for example a passenger car, a truck or a motorcycle, but also an air-bound vehicle such as a quadrocopter or a water-bound vehicle such as a ship. An electrically powered vehicle can be understood as a vehicle with an electric drive motor, such as an electric car. A high-voltage voltage can be, for example, a voltage of at least 60V, preferably at least 200V, particularly preferably at least 380V and most preferably at least 780V.

The process comprises a series of process steps. One process step is providing a busbar body made of a copper metal or of an aluminum metal as an oxide-layer-forming metal. The busbar body and thus the busbar is preferably flat. Accordingly, a thickness measured in a thickness direction transverse to the main direction of extension (along its course) of the busbar is smaller, at least in sections, i.e. in sections or over the entire busbar, than a width of the busbar measured in a thickness direction transverse to the thickness direction and transverse to the main direction of extension. For example, the width can be at least twice as large as the thickness. The width can also vary along the busbar. For example, it can be at least five times as wide as the thickness, preferably at least ten times as wide, at least in sections. Any tabs (potentially provided for fastening) can be disregarded. The busbar can have minimum dimensions with an overall length of at least 150 mm and/or a thickness of at least 3 mm and/or a width of at least 20 mm.

The copper or aluminum metal is preferably copper or aluminum, but can also be a copper alloy or aluminum alloy. In principle, further elements can be provided on the busbar body, for example fastening elements such as eyelet inserts and the like. In contrast to conductor-wire braid-based power lines, the busbar body has a solid structure, i.e. has a continuous cross-section area in the respective metal. Preferably, the busbar body has an essentially rectangular cross-section (i.e. in particular apart from rounded edges). In contrast to the usual flexible power lines based on conductor-wire braiding, the busbar is a rigid power line.

The busbar body has a first contact region and at least one further contact region spatially separated from the first contact region, i.e. one or more further contact regions spatially separated from the first contact region and/or one another. The contact regions are each meant for a corresponding first or further contact surface for establishing electrical contact with the busbar body and thus serve to transmit current through the busbar. When the busbar is used as intended, the contact surfaces are thus in electrical contact with other current-carrying components in the vehicle, so that a current can flow between the different contact surfaces and thus between the different contact regions. For example, a charging current of more than 10 A or even more than 100 A can be conducted through the busbar. Accordingly, the busbar is preferably designed for high currents of more than 10 A, preferably more than 100 A. Each contact surface can be assigned to a current-carrying component and/or each current-carrying component can be assigned to a contact surface. A respective through-opening can be provided in one, several or all of the contact regions. This allows the busbar, or more precisely the associated contact surface, to be pressed particularly well against the other current-carrying component, for example by using a screw. However, this can also be achieved by other means and/or without a through hole. The contact surface is therefore designed for a clamping contact.

A further process step is spraying at least one of the contact regions with a material stream of a molten corrosion-protective and thus contact-maintaining metal and thus building up, in particular forming, the contact surface with or by coating the contact region with the corrosion-protective metal. The corrosion-protective metal prevents corrosion, in particular oxidation of the busbar body, and is thus contact-maintaining in the sense that it contributes to the durability of an electrical contact established via the contact region and/or the contact surface. The corrosion-protective metal may also oxidize itself, but in a way that does not impair the electrical contact or impairs it less than the metal of the busbar body. In the case of tin, for example, a thin and brittle oxide layer is formed, which breaks open under the contact pressure of the contact surface on the current-carrying component and thus still allows contact to be made with the unoxidized, softer tin that was previously under the oxide layer. The unoxidized softer tin adapts to the shape of the mating contact surface of the other current-carrying component under pressure and thus ensures a particularly low contact resistance. The same applies to silver. As transport protection, the contact surface sprayed with the metal can also be provided with a volatile layer, such as a wax layer, which evaporates under the contact pressure during contacting.

The spraying can also be referred to as partial or area-by-area spraying, as it can (essentially) be limited to the respective contact regions. In contrast to the known galvanic processes, only a partial area of the busbar body is coated, i.e. sprayed in the present case. A major part of the busbar body is thus not sprayed, only a small part of at least less than 50%, preferably less than 25%, particularly preferably less than 10% of the total surface of the busbar body is sprayed. The non-sprayed and thus not coated with the corrosion-protective metal (i.e. uncoated) major part of the busbar body can accordingly be referred to as the central region. In particular, the uncoated central region separates at least two, more than two or all contact regions. In particular, spraying can therefore be carried out exclusively in the contact regions (in particular with the exception of possible transition areas, which can occur due to spatially blurred spraying between the contact region and the central region). For better material savings, the central region can therefore be covered with a spray mask to prevent spraying onto the central region. This allows clearly defined and delimited contact regions to be created.

During the spraying, the molten metal droplets of the material stream are carried from a spraying device to the contact region by a stream of inert gas and/or (atmospheric) air, for example, and hit the busbar body while losing their droplet shape. They cool down and adhere to the busbar body, the busbar body is plated accordingly by the droplets. The coating of the busbar body created in this way by the corrosion-protective metal can have a thickness of at least 30 μm and/or at most 50 μm. Preferably, the coating of the busbar body has a thickness of at least 10 μm on the contact surface. With this minimum thickness, it can be ensured that the busbar body is completely covered and protected against oxidation in the area of the contact surface, i.e. the surface that makes electrical contact with the respective other component when used as intended. This also contributes to durability in particular after loosening and reattaching the busbar to respective other components, for instance in a repair process of the vehicle. In particular, the spraying is carried out evenly so that the coating thickness in the contact region is as homogeneous as possible. This allows the coating to take on the contour of the busbar body. The contact resistance is reduced by avoiding oxide inclusions in the coating. This can be done depending on the properties of the busbar and/or the contact surfaces. Oxide inclusions can be avoided, for example, by adapting the temperature of the material stream and the busbar body to each other and by adapting the nozzle diameter of a nozzle used for spraying and the strength of the flow of shielding gas and/or (atmospheric) air to each other.

The approach described has a whole range of advantages. Firstly, partial spraying reduces the amount of corrosion-protective metal required and therefore also the energy needed for coating. In addition, spraying is an easy-to-handle technology; unlike galvanic processes, it does not involve any chemicals that are harmful to the environment. The coating can also be applied locally close to other process steps, such as press-punching the busbar body, which saves on transportation routes and other resources. A manufacturing step preceding the spraying, such as the aforementioned press-punching, can therefore take place within the same building and/or within the same contiguous (company) site and/or within a radius of a few, for example two, kilometers. This saves a considerable amount of time and speeds up the production of the high-voltage busbar. As the molten corrosion-protective metal cools and solidifies almost immediately on contact with the busbar body, it is also possible, for example, to coat different disjoint contact regions (separated by the central region) with just one (pulsed) spraying device by reorienting the partially sprayed busbar body between two material stream pulses. In contrast to electroplating, in which the busbar bodies have to be individually attached to a frame by hand, this can be done fully automatically, for example with a robot arm. It is very advantageous that spraying and fixing (in this case melting) of the corrosion-protective metal are combined, i.e. carried out simultaneously in a single process. This not only saves time, but also ensures that the coating can be carried out independently of the orientation of the surface to be coated in the earth's gravitational field—for example, parallel to the earth's surface from different sides, which significantly increases the flexibility with regard to the shape of the busbar with a short process duration.

In one embodiment, tin and/or zinc and/or nickel and/or silver are used as corrosion-protective metals during spraying. These metals have proven to be advantageous, as they prevent oxidation of the copper or aluminum contact region, adhere well to the busbar body during spraying and maintain good electrical contact (despite any oxidation). The softer metals such as tin and zinc are particularly advantageous here, as they are deformable under the contact pressures that occur on the contact surfaces, for example when the busbar is bolted to the other current-conducting components of the vehicle. This further improves the electrical contact. Mixtures of the metals mentioned or with the metals mentioned can also be used for spraying.

It is particularly advantageous here if the busbar body is made of copper metal and the contact surface is formed with only one corrosion-protective metal during spraying, in particular only with tin (a tin layer). This combination has proven to be particularly reliable for spraying. This is not the case in other processes, such as cold plasma coating. Therefore, reliable contacting is achieved in this case even without further adhesive layers. Repeated spraying with different metals and/or different metal mixtures is also possible.

In a further embodiment, the material stream is generated with or by melting the corrosion-protective material in a spraying device, in particular a spray gun. The spray gun in particular, as is basically known from painting work, for example, is an established technology that can be used in good quality largely independent of location.

In one embodiment, metal for the material stream is melted by means of an electric arc or a flame. Preferably, the melting takes place after the material is provided in the form of a wire. This makes the corrosion-protective material particularly easy to feed or particularly easy to melt locally (e.g. in the spray gun) and spray or blow onto the busbar body.

In another embodiment, it is provided that the at least one contact region to be sprayed is roughened before spraying, preferably by sandblasting. The roughening can alternatively or additionally be carried out by other means, for example by grinding and/or glass blasting and/or laser blasting. This has the advantage of using easily accessible technology to improve the adhesion of the corrosion-protective metal and thus the long-term performance of the busbar.

In a further embodiment, it is provided that only sides of the busbar body that run along the main extension plane are sprayed during spraying. The main extension plane can be a local main extension plane in the contact region. In particular, only one side of the busbar body is sprayed in each contact region. In this way, precisely those (contact) surfaces of the busbar body that are pressed against the current-carrying components of the vehicle during intended use can be sprayed and coated to save material. Edges of the busbar body and areas of the busbar body diametrically opposite the contact surfaces in the thickness direction, which do not serve to transmit current to the current-carrying components of the vehicle, are accordingly not sprayed.

In another embodiment, it is envisaged that several contact regions are sprayed and that the spraying of different contact regions is carried out from different directions. Accordingly, the contact surfaces created or built-up during spraying are at least partially oriented differently, in particular in opposite directions. At least one contact surface is therefore oriented differently to at least one further contact surface. This has the advantage that even more complex busbar geometries can be coated in a simple, resource-saving and durable manner, thereby improving their performance. In particular, the differently oriented contact regions can be coated simultaneously or overlapping in time with the proposed spraying, as the application of the corrosion-protective metal and the fusion with the busbar body takes place in a single step and independently of the orientation in a gravitational field of the earth.

In one embodiment, it is provided that several contact surfaces are sprayed and the contact surfaces run in different planes, i.e. more than one plane. In particular, this can be done despite the same orientation, so the different planes can run parallel at one or more different distances from the spraying device. The process can therefore be used to coat many different busbar geometries with little effort and still achieve a high quality coating. Accordingly, the spraying device does not have to be tracked at a precise distance from the busbar geometry.

A further aspect relates to a high-voltage busbar for transmitting current in a vehicle, in particular in an electrically powered vehicle. The high-voltage busbar has a first contact surface, which is designed to establish electrical contact with the busbar and is arranged in a first contact region of the busbar, and at least one further contact surface, which is designed to establish electrical contact with the busbar and is arranged in a respective further contact region of the busbar. The busbar is essentially made of an oxide-layer-forming metal and at least the first contact surface is formed as a partial surface spatially separated from the further contact surface or surfaces with a corrosion-protective metal. The at least one contact surface formed with (i.e. including) the corrosion-protective metal is made by spraying the molten corrosion-protective metal onto the respective contact region. In comparison to galvanic coating processes and dip coating processes, this can already be confirmed visually with the naked eye, for example by means of flow marks (present or absent), drip noses (present or absent) and the shape typical of metal droplets striking and solidifying on the busbar body.

Yet another aspect relates to a vehicle with such a high-voltage busbar and/or one or more current-carrying components for the vehicle with such a high-voltage busbar.

Advantages and advantageous embodiments of the latter aspects corresponding to the advantages and advantageous embodiments described for the former aspect and vice versa.

The described features and combinations of features, including those of the general introduction, as well as the features and combinations of features disclosed in the figure description or the figures alone can be used not only alone or in the described combination, but also with other features or without some of the disclosed features, without departing from the scope of the invention. Consequently, embodiments which are not explicitly shown and described in the figures, but which can be generated by separately combining the individual features disclosed in the figures, are also part of the invention. Therefore, embodiments and combinations of features which do not comprise all features of an originally formulated independent claim are also to be regarded as disclosed. Furthermore, embodiments and combinations of features which deviate from the combinations of features or go beyond those described in the dependencies of the claims are to be regarded as disclosed.

In the context of the present disclosure, the term “transverse/along” can be understood as “at least substantially vertical/parallel”, i.e. “vertical/parallel” or “substantially vertical/parallel”, i.e. vertical/parallel except for a predetermined deviation. The predetermined deviation can, for example, be at most 15°, preferably at most 5°, particularly preferably at most 3°. Accordingly, “oppositely oriented” in the context of the present disclosure can be understood as “at least substantially oppositely oriented”, i.e. “at least substantially antiparallel oriented”. The restriction “essentially” can also refer to a maximum permissible deviation specified as a percentage, for example at most 15%, preferably at most 5%, particularly preferably at most 3%.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a first exemplary embodiment of a sprayed high-voltage busbar;

FIG. 2 shows another exemplary embodiment of a sprayed high-voltage busbar;

FIG. 3 shows yet another exemplary embodiment of a sprayed high-voltage busbar; and

FIG. 4 shows a schematic representation of a spraying device, by means of which a method for spraying a contact region of high-voltage busbars is explained.

In the drawings, reference numbers may be reused to identify similar and/or identical elements.

### DETAILED DESCRIPTION

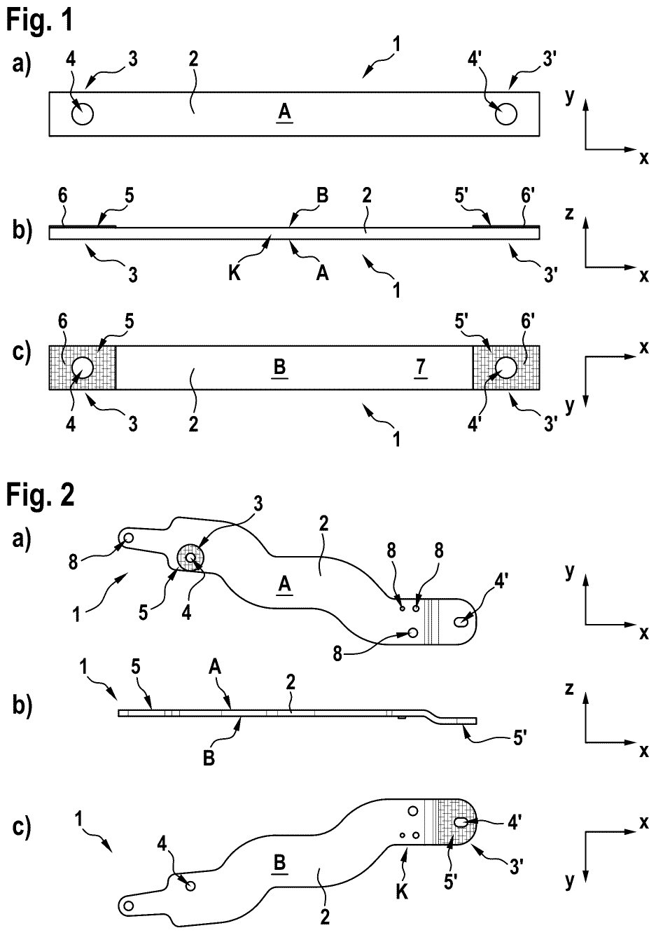

FIG. 1 shows the exemplary high-voltage busbar shown in the different partial images a), b) c) from three different directions. In this case, the busbar 1 is a straight busbar 1 whose main direction of extension, its course, runs in the x-direction. A length of the busbar 1 is measured in the main direction of extension, a thickness of the busbar 1 in the z-direction and a width of the busbar 1 in the y-direction.

In FIG. 1a, the busbar is shown from an uncoated side A, which has not been sprayed and thus coated with the described method. A busbar body 2 is made of copper in the present case and has a respective through-opening 4, 4′ in a first contact region 3 and at least one, here exactly one, further contact region 3′ for screwing the busbar 1 to current-carrying components in the vehicle.

In the side view shown in FIG. 1b, the likewise unsprayed edge K of the busbar 1 and/or the busbar body 2 is shown. In the contact regions 3, 3′, the busbar body 2 has a respective coating 6, 6′—a partial coating 6, 6′ of the busbar 1 and/or the busbar body 2—which in the present case is slightly raised compared to the busbar 1 in the uncoated areas on side B.

FIG. 1c now shows the partially or partly coated side B of the busbar 1. The contact regions 3, 3′ are arranged on the same side B here and separated by an uncoated central region 7. The contact regions 3, 3′ can be arranged in an edge region, i.e. at an edge K, but do not have to be. It is advantageous if the through-openings 4, 4′ are each located in the contact region 5, 5′ and are therefore surrounded by it. When used as intended, the busbar body 2 is therefore coated in the area of maximum contact pressure on the current-carrying components of the vehicle, which makes the electrical coupling particularly resource-efficient and reliable thanks to the spray process used.

Analogous to FIG. 1, FIG. 2 shows, in subfigures a)-c), a further exemplary embodiment of a high-voltage busbar, as can be produced in a resource-efficient manner using the process described.

Once again, the busbar 1 has two contact surfaces 5, 5′, which in this case, however, have an opposite orientation, i.e. are arranged on the opposite sides A, B of the busbar 1. In the main extension plane of the busbar, the x-y plane, the busbar 1 has curves, in contrast to the rectangular-straight design of FIG. 1. The first contact surface 5 extends circularly around the first through hole 4, while the second contact surface 5′ extends in an edge region that is offset in the z-direction from the remaining busbar 1, i.e. offset in the z-direction in relation to the remaining busbar 1, as contact region 3′ up to the edge K of the busbar 1 and/or the offset edge. The process can therefore be used to coat varying busbar geometries in an extremely flexible, efficient, resource-saving and durable manner.

Furthermore, in the example shown, the busbar 1 has a series of additional through holes 8, in the surrounding region of which no coating 6, 6′ is applied. Here, for example, smaller consumers can be connected to the busbar 1 or the busbar 1 can be additionally attached to the vehicle, i.e. without electrical functionality, for example.

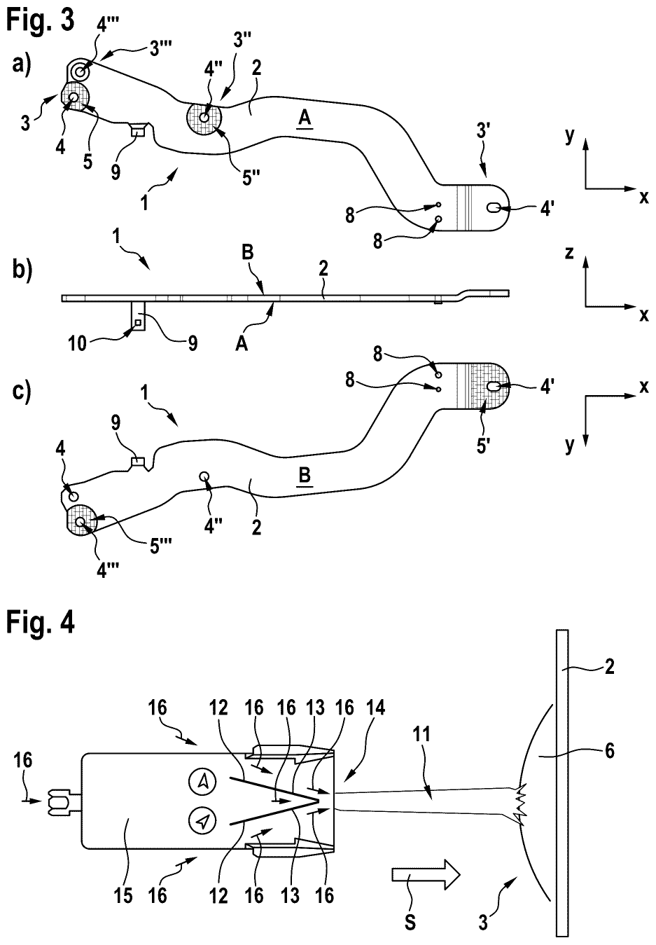

To illustrate the versatility of the method described, FIG. 3 shows, in subfigures a)-c), a further exemplary embodiment of a busbar 1 with several contact surfaces 5, 5′, 5″, 5′. The contact surfaces 5, 5′, 5″, 5′″ are each arranged around corresponding through openings 4, 4′, 4″, 4′″ and are again either circular or extend to the next edge K and/or offset edge. A terminal area, in which the further contact surface 5′ is also arranged, is offset in the z-direction in relation to the rest of the busbar 1. Accordingly, the further contact surfaces 5′ and 5″ run in different (in this case parallel) planes despite having the same orientation, i.e. being arranged on the same side B. The first contact surface 5 and the further contact surface 5″ (which are both arranged on side A of the busbar and have the same orientation to each other) are oriented in the opposite direction to the further contact surfaces 5′ and 5″.

In the example shown, the busbar 1 also has a tab 9, which extends mainly in the z-x plane and thus transversely to the main plane of extension of the busbar 1. The tab 9 has a through hole 10 for fastening and/or electrical contacting, but no coating and therefore no improved contact surface in the sense of the spray process described. However, the method could easily be used to spray a contact region around the through hole 10 and thus coat it, i.e. improve it in terms of permanently increased electrical conductivity. Since spraying is independent of orientation, this can also be carried out at the same time as spraying the other contact regions 3, 3′, 3″, 3″ and thus in particular after bending the tab in the other plane (z-x plane compared to the x-y plane). The busbar body 2, which is finished in a bending-punching process, can therefore be coated so that, in contrast to applying the coating with subsequent bending, damage to the coating or the contact surface is avoided.

FIG. 4 shows a schematic representation of a spraying device during the manufacture of a high-voltage busbar for current transmission in a vehicle. It shows the spraying of a contact region 3 of the busbar body 2 with a material stream 11 of a molten corrosion-protective metal 12 such as tin after the busbar body 2 has been prepared.

Here, the metal 12 is guided in the form of one or more wires 13 in a mouth area 14 of the spraying device 15 into the area of an electric arc and melts there. By means of an air or gas flow symbolized by arrows 16, molten metal droplets are entrained in the spraying direction S and the material stream 11 is generated. The spray direction S can be selected largely independently of the earth's gravitational field. The metal droplets burst on the surface of the busbar body 2 in the contact region 3, the metal 12 solidifies again and then forms the contact surface 5 in the example shown, in general a coating which covers the contact surface 5 or an adhesive layer under the contact surface 5.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method for transmitting current in an electrically driven vehicle, the method comprising:
providing a busbar body made of a copper metal or of an aluminum metal as an oxide-layer-forming metal, the busbar body having a first contact region and at least one further contact region, each meant for a corresponding contact surface for establishing an electrical contact with the busbar body, wherein the at least one further contact region is spatially separate from the first contact region; and
spraying at least one of the contact regions with a material stream of a molten corrosion-protective metal and thereby building up the contact surface.

2. The method of claim 1, wherein:
at least one of tin, silver, or nickel is used as the corrosion-protective metal in the spraying.

3. The method of claim 2, wherein:
the busbar body consists of the copper metal, and
during spraying, the contact surface is formed with only one corrosion-protective metal.

4. The method of claim 3, wherein the corrosion-protective material is tin.

5. The method of claim 1, wherein:
the spraying of the at least one contact region is carried out several times with different corrosion-protective metals.

6. The method of claim 1, wherein:
the contact regions are separated by a central region that is not coated by the corrosion-protective metal and occupies a major part of the surface of the busbar body.

7. The method of claim 1, wherein:
the material stream is made with melting the corrosion-protective metal in a spraying device.

8. The method of claim 7, wherein the spraying device is a spray gun.

9. The method of claim 1, wherein:
the metal for the material stream is melted by an electric arc or a flame.

10. The method of claim 9, wherein the metal for the material stream is melted after the metal for the material stream is provided as a wire.

11. The method of claim 1, wherein:
before spraying, the at least one contact region to be sprayed is roughened.

12. The method of claim 11, wherein the at least one contact region to be sprayed is roughened by sandblasting.

13. The method of claim 1, wherein:
during spraying, only sides of the busbar body which extend along a main extension plane are sprayed.

14. The method of claim 13, wherein only one side of the busbar body is sprayed in each contact region.

15. The method of claim 1, wherein:
several contact regions are sprayed, and
the spraying of different contact regions is carried out from different directions so that built-up contact surfaces are at least partially oriented differently.

16. The method of claim 1, wherein:
a plurality of contact surfaces are sprayed and the contact surfaces run in different planes despite having a same orientation.

17. A high-voltage busbar for transmitting current in an electrically driven vehicle, the busbar comprising:
a first contact surface designed to establish electrical contact with the busbar and arranged in a first contact region of the busbar; and
at least one further contact surface designed to establish electrical contact with the busbar and arranged in a respective further contact region of the busbar, wherein:
the busbar is made of an oxide-layer-forming metal,
at least the first contact surface is formed as a partial surface with a corrosion-protective metal spatially separated from the at least one further contact surface, and
the at least one contact surface formed with the corrosion-protective metal is produced by spraying the corrosion-protective metal onto the respective contact region.

18. A vehicle including the busbar of claim 17.
